(19) United States
(12) Patent Application Publication
(10) Pub. No.: US 2017/0247837 A1
(43) Pub. Date: Aug. 31, 2017

(54) LAMINATE, PROCESS, AND USE

(71) Applicant: David Asher KANTER EIVIN, Toronto (CA)

(72) Inventor: David Asher KANTER EIVIN, Toronto (CA)

(21) Appl. No.: 15/442,168

(22) Filed: Feb. 24, 2017

Related U.S. Application Data
(60) Provisional application No. 62/300,385, filed on Feb. 26, 2016.

(51) Int. Cl. D21F 11/04; B32B 7/12; C09D 105/00; D21F 11/00; C13K 1/02

(52) U.S. Cl. CPC D21F 11/04; D21F 11/00; C13K 1/02; C09D 105/00; B32B 7/12

(57) ABSTRACT

A paper, or cardboard, or card stock material is made from an organic material, such as ground-up sunflower seeds using an organic binder, such as a glue, which may have the form of a polysaccharide e.g., a long chain naturally occurring sugar. A water resistant, or water impermeable coating, such as a PLA coating, is applied to one or both sides of the card stock to form a laminate. The card stock may be formed into a shape or structure, such as a carton, or bowl, or cup, either prior to or after coating. The card stock material or the primary layer, the binder, and the plastic coating are all based on materials that are typically considered to be waste by-products of agricultural or food services processing, and they are all materials that may tend to be suitable for composting or biodegradation.

This application claims the benefit of priority of U.S. Provisional Patent Application U.S. Ser. No. 62/300,385 filed Feb. 26, 2016, the specification and drawings thereof being incorporated by reference herein in their entirety.

### FIELD OF THE INVENTION

This invention relates to the field of biodegradable laminates, processes, and uses.

### BACKGROUND OF THE INVENTION

Single use disposable containers are ubiquitous in North America. One kind of single use container employs a liquid barrier layer in the form of a coating placed on a paper cardstock. Although such containers may be intended to be recyclable or biodegradable, this is not always the case in practice.

### SUMMARY OF THE INVENTION

In an aspect of the invention there is a card stock laminate. It has a first layer and a second layer. The first layer is a lignocellulosic web. The second layer is a thermoplastic aliphatic polyester applied to the lignocellulosic web. The first layer has a binder. The binder is non-toxic and water soluble.

In a feature of that aspect of the invention, the lignocellulosic web is formed from a non-wood material. In another feature, the lignocellulosic material is formed from an agricultural plant waste product. In still another feature, the lignocellulosic material is chosen from the set of lignocellulosic materials consisting of: (a) non-staining fruit rinds; (b) non-staining nut rinds; and (c) grain husks. In a further feature, the lignocellulosic web is made at least predominantly of sunflower seed shells.

In another feature of the invention, the binder is chosen from (a) a protein glue; and (b) a polysaccharide. In a particular embodiment, the binder is a polysaccharide. In another feature, the binder is a vegetable oil-based gum. In another feature, the binder is a starch. In still another feature, the binder is a xanthan gum.

In yet another feature, the laminate has a thickness of greater than 0.25 mm (0.010 inches). In a further feature, the laminate if formed into the shape of a liquid containment vessel, the liquid containment vessel having an inside surface, and the liquid containment vessel has the thermoplastic aliphatic polyester applied to the inside surface. In another feature, the liquid containment vessel is a drinking cup. In another feature, the web is free of clays. In another feature, the first layer is made of a sunflower paper cardstock, the second layer is a thermoplastic aliphatic polyester applied to the sunflower paper cardstock, and the binder includes xanthan gum.

In another aspect of the invention there is a method of making a laminate card stock. The method includes converting an agricultural plant product waste to a paper-making input feedstock; mixing the feedstock with a binder, the binder being non-toxic and water-soluble; producing a slurry of the input feedstock and the binder; at least partially drying the slurry to produce a first web; and applying a thermoplastic aliphatic polyester to one side of the first web.

In a feature of that aspect of the invention, the method includes choosing the plant product waste to include at least one of: corn husks; corn stalks; chaff of any of wheat, oats, canola and barley; non-staining seed shells; straw; non-staining nut shells and husks. in another feature, the method includes choosing the binder to include at least one of (a) a protein; and (b) a polysaccharide. In still another feature, the method includes choosing the agricultural waste to include sunflower seeds shells. In yet another feature, the method includes choosing the binder to include a xanthate gum.

In still another feature, the method includes grinding the agricultural plant product waste to a powder. In a further feature, the method includes mixing a bleach with the slurry. In another feature, the bleach is less than ¼% by weight of the slurry. In yet another feature, the method includes forming the slurry on a screen and extracting moisture therefrom to form the first web. In still yet another feature, the method includes applying the thermoplastic aliphatic polyester to the first web while the web is moist.

In a further feature, the agricultural waste product is at least predominantly sunflower seed husks; the binder is a xanthate gum; the step of converting includes grinding the sunflower seed husks into a powder; the step of at least partially drying the slurry includes forming the slurry into a web and extracting moisture therefrom; and the thermoplastic aliphatic polyester is applied to one side of the web while the first web is moist. In another feature, the method includes forming the first web into a vessel and applying the thermoplastic aliphatic polyester to an inside surface of the vessel. In yet another feature, the first web if formed to a thickness of at least 0.25 mm thick (0.010 inches). In still another feature, the method includes forming the laminate into a paper cup.

In another aspect of the invention there is a cardstock that has a sunflower shell web with a thermoplastic aliphatic polyester coating applied to at least one side thereof.

### BRIEF DESCRIPTION OF THE DRAWINGS

These aspects and other features of the invention can be understood with the aid of the following illustrations of a number of exemplary, and non-limiting, embodiments of the principles of the invention in which:

FIG. 1 shows a side view of a container;

FIG. 2 shows a top view of the container of FIG. 1;

FIG. 3 is a sectional view of the wall structure of the container of FIG. 1;

### DETAILED DESCRIPTION

The description that follows, and the embodiments described therein, are provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings may be understood to be to scale and in proportion unless otherwise noted. The wording used herein is intended to include both singular and plural where such would be understood, and to include synonyms or analogous terminology to the terminology used, and to include equivalents thereof in English or in any language into which this specification may be translated, without being limited to specific words or phrases. “The term “polysaccharide” as used herein, is a broad term and is used in its ordinary sense, including, without limitation, saccharides having a plurality of repeating units, including, but not limited to polysaccharides having 50 or more repeat units, and oligosaccharides having 50 or less repeating units. Typically, polysaccharides have from about 50, 55, 60, 65, 70, 75, 80, 85, 90, or 95 repeating units to about 2,000 or more repeating units, and preferably from about 100, 150, 200, 250, 300, 350, 400, 500, 600, 700, 800, 900 or 1000 repeating units to about, 1100, 1200, 1300, 1400, 1500, 1600, 1700, 1800, or 1900 repeating units. Oligosaccharides typically have from about 6, 7, 8, 9, or 10 repeating units to about 15, 20, 25, 30, or 35 to about 40 or 45 repeating units.

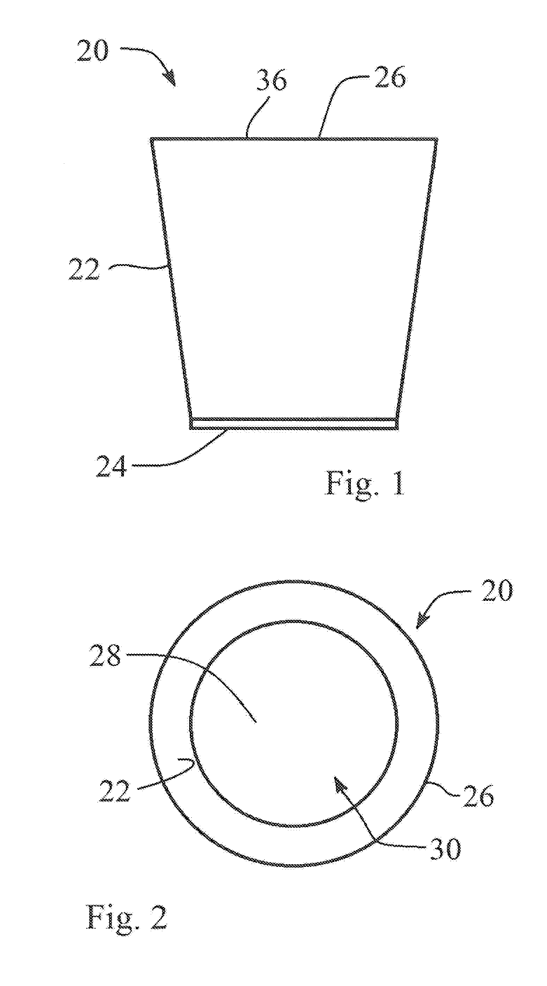

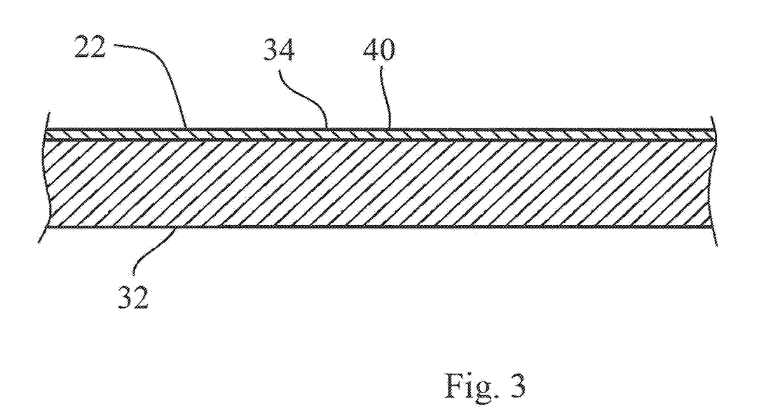

Referring to FIGS. 1 and 2, a containment vessel for holding liquids is identified generally as 20. Containment vessel 20 has a generally upstanding sidewall 22 and a base 24 upon which it may sit on a supporting surface. Sidewall 24 may be tapered upwardly and outwardly in the manner of a cup. It may have an upper rim, as at 26, and a bottom panel 28. Bottom wall 28 and sidewall 22 co-operate to define a chamber, indicated generally as 30, for containing liquids.

Containment vessel 20 is intended to be generic. That is, while it may have the general shape of a cup, the container could have a square or rectangular base, and could be straight sided. It could have a top, or cover, or lid, and it could have the shape of a folded carton, whether a milk carton or a folded rectangular cubic drink box, or juice box, or box for soup, and so on. Alternatively it could have the shape of a shallow container, such as a wide bowl or paper plate. In each case, the structure is intended to define a continuous geometric surface or shell such as may be used to contain a liquid, or to deter the migration of a liquid.

FIG. 3 shows a cross-section of a portion of upstanding wall 22, or of bottom wall 28. The thicknesses have been greatly exaggerated for the purposes of illustration. As can be seen, the wall structure is made of a sheet stock, or web, having a first layer indicated as 32, and a second layer indicated as 34. Rim 26 defines the periphery of an opening 36 through which materials may be placed in or withdrawn from chamber 30. Such materials may be liquids, or materials from which liquids may tend to seep or drip.

First layer 32 may be the primary layer, or substrate of the web stock 40. It may be a form of paper, or cardboard, or card stock, that is formed predominantly, or substantially entirely of a base material that is a lignocellulosic material. The materials are also water absorbent. In particular, the lignocellulosic material may be an unused discard, or waste, or by-product of an agricultural activity. In this specification, agricultural activities include food processing or food preparation or food serving processes or products or activities. These activities may include such processes as removing shells from seed or nuts, or husks from corn. Sunflower seed shells or husks are such a material. There are some agricultural products that may be avoided. For example, such materials as considered for use herein are non-toxic. In some embodiments it may be that materials tending to yield strong dyes, or stains, may be avoided, as may materials tending to have strongly undesirable colours. Although natural colouring may be applied to the as finished product, or may be mixed with the base material during processing, typical materials may be chosen that have a subdued, pale, or pastel colour, such as a gray, or beige, or light brown, and so on. Alternate materials may include pumpkin hulls (though they may be more prone to allergies than sunflowers), almonds and other seed hulls or nut shells that are fairly soft and high in cellulose. It may be desirable to avoid materials that may commonly cause allergic reactions.

The producers of waste agricultural or food processing materials may tend to view those materials as a cost, in terms of disposal. However, using a waste materials from such a process may be desired as it may solve a disposal problem for the first user, and provide economical feedstock for the cardstock producer. A further desirable feature may be the re-usability of the material. A still further desirable feature may be that such materials may be suitable for subsequent re-processing. Further, agricultural by-product feedstocks, being by definition organic, may be biodegradable or suitable for composting.

The base material of the card stock may be processed into small particulate, where “small” my be understood to be of a size to make a pulp or powder. The materials may be ground into a dry powder or may be processed mechanically into a pulp. The base material, once rendered into a fine form, may be stored until ready for use. A small amount of bleach may be added to discourage the growth of molds. In this context, “small” may be defined as less than 1/10of 1% by weight, where the bleach is, typically, common household bleach containing between 3-8% sodium hypochlorite and 0.01% to 0.05% sodium hydroxide.

A binder may be added to the base material. The binder may have the form of a resin. The binder may be a water-soluble binder. It may be a protein, such as a casein glue. Alternatively it may be a polysaccharide. It may by a carbohydrate. It may be a starch. In one embodiment it may be a gum, such as a xanthate, one of which is xanthan gum. As with the base material, the binder may be, or may be derived from, a discarded material, such as may be a by-product or discard of an agricultural or food processing activity. Casein glues are such a material. Polysaccharides may be obtained from many kinds of agricultural plant waste. A typical source material for polysaccharides may be a vegetable oil, e.g., a corn oil.

The base material and binder may be mixed with water to form a slurry in a bath, or receptacle or tub. When the slurry is evenly mixed, and smooth, it may be extracted from the bath on a screen. The extracted material may then be dried to extract the moisture, and to leave a wafer, or layer, or membrane that, when dried forms a coherent sheet. Although clays and other materials may be used, in some embodiments the card stock paper may be free of such clays. Further, the card stock paper may be calendared, i.e., passed between rollers to yield a smooth finish. In some instances the card stock may be subsequently pressed into a shaped by a form or mold. Such forming may occur while the card stock is partially moist.

Second layer 34 may be a water-retaining coating, or water barrier coating, or moisture barrier coating, or water impermeable coating, or water-proof coating, however it may be termed, and may be much thinner than the main substrate. That is, the coating layer may be of the order of less than 2 mils thick. Thicker coatings may be applied. However it may be that extra thickness may not be required. The coating may be in the nature of a PLA plastic, namely a thermoplastic aliphatic polyester with a temperature for use above the boiling temperature of water. Such PLA plastics may themselves be by-products or discarded waste of agricultural or food processing activities. That is, a common source of PLA feedstock is corn starch. Corn starch tends to be readily available in North America, and there are commercial manufacturers of PLA. A typical PLA plastic may have a melting temperature in the range of 173-178 C, which is well above the customary temperature range for serving beverages and foodstuffs, such as coffee, tea, or soup.

The PLA may be applied to the card stock either before or after forming of the card stock into the shape of a containment vessel. It may be applied by spraying, or by mechanical application, or by printing, whether on the card stock in a traditional manner, or by 3-D printing on the surface of the already-formed object. The PLA may be applied to the card stock structure while that structure is still moist. Subsequent drying may yield the laminate structure of FIG. 3. In addition to PLA, other materials we could use for the plastic are PDLA, biodegradable polylactide aliphatic copolymer (CPLA) and other bioplastics. PLA may tend to be biodegradable, and may degrade in 45 to 90 days, depending on the temperature. It may take less time in an industrial composter, and more time, perhaps as much as 6 months, if put in a backyard composter. PLA may tend not to need sunlight to biodegrade, although sunlight, may improve the speed of the breakdown. PLA may tend to need air to biodegrade more rapidly. That is, it may take 4 to 6 years to decompose in a landfill that is relatively airtight.

Where the card stock is formed into a liquid containment vessel, the PLA may be applied to one side of the structure. PLA could be applied to both sides of the structure if desired. It may typically be that application to one side—i.e., the inside of a cup or carton or bowl—will establish the desired waterproof qualities. The plastic coating is very thin, and, as such, provides little by way of resistance to heat transfer. The paper or card stock substrate may be a more effective thermal insulator. The paper or card-stock also provides structural stiffness by which the walls of the container or containment structure maintain their form when full, and when warmed by the contents.

The embodiments illustrated and described above illustrate individual non-limiting examples in which the principles of the present invention are employed. It is possible to make other embodiments that employ the principles of the invention and that fall within the following claims. To the extent that the features of those examples are not mutually exclusive of each other, the features of the various embodiments may be mixed-and-matched, i.e., combined, in such manner as may be appropriate, without having to resort to repetitive description of those features in respect of each possible combination or permutation. The invention is not limited to the specific examples or details which are given by way of illustration herein, but only by the claims, as mandated by law. The claims are to be given the benefit of purposive interpretation to include equivalents under the doctrine of equivalents.

Although the various embodiments have been illustrated and described herein, the principles of the present invention are not limited to these specific examples which are given by way of illustration, but only by a purposive reading of the claims.

I claim:

1. A laminate comprising:
a first layer and a second layer;
said first layer being a lignocellulosic web;
said second layer being a thermoplastic aliphatic polyester applied to said lignocellulosic web;
said first layer having a binder, said binder being non-toxic and water soluble.

2. The laminate of claim 1 wherein said lignocellulosic web is formed from an agricultural plant waste product.

3. The laminate of claim 1 wherein the materials of said lignocellulosic web is chosen from the set of lignocellulosic materials consisting of:
(a) non-staining fruit rinds;
(b) non-staining nut rinds;
(c) grain husks; and
(d) a material that is made at least predominantly of sunflower seed shells.

4. The laminate of claim 1 wherein said binder is chosen from (a) a protein glue; and (b) a polysaccharide.

5. The laminate of claim 1 wherein said binder is, or includes at least one of:
(a) a polysaccharide;
(b) a vegetable oil-based gum;
(c) a starch; and
(d) a xanthan gum.

6. The laminate of claim 1 wherein said laminate has a thickness of greater than 0.25 mm (0.010 inches).

7. The laminate of claim 1 wherein said laminate if formed into the shape of a liquid containment vessel, said liquid containment vessel having an inside surface, and said liquid containment vessel has said thermoplastic aliphatic polyester applied to said inside surface.

8. The laminate of claim 7 wherein said liquid containment vessel is a drinking cup.

9. The laminate of claim 1 wherein said web is free of clays.

10. The laminate of claim 1 wherein said first layer is made of a sunflower paper cardstock, said second layer is a thermoplastic aliphatic polyester applied to said sunflower paper cardstock;
and the binder includes xanthan gum.

11. A method of making a laminate, said method comprising:
converting an agricultural plant product waste to a paper-making input feedstock;
mixing said feedstock with a binder, said binder being non-toxic and water-soluble;
producing a slurry of said input feedstock and said binder;
at least partially drying said slurry to produce a first web; and
applying a thermoplastic aliphatic polyester to one side of said first web.

12. The method of claim 11 wherein said method includes choosing said plant product waste to include at least one of: corn husks; corn stalks; chaff of any of wheat, oats, canola and barley;
non-staining seed shells; straw; non-staining nut shells and husks; and sunflower seed shells.

13. The method of claim 11 wherein said method includes choosing said binder to include at least one of (a) a protein; (b) a polysaccharide; and (c) a xanthate gum.

14. The method of claim 11 wherein said method includes at least one of
(a) grinding said agricultural plant product waste to a powder;
(b) mixing a bleach with said slurry;
(c) forming said slurry on a screen and extracting moisture therefrom to form said first web; and
(d) includes applying said thermoplastic aliphatic polyester to said first web while said web is moist.

15. The method of claim 22 wherein bleach is less than ¼% by weight of said slurry.

16. The method of claim 11 wherein:
said agricultural waste product is at least predominantly sunflower seed husks;
said binder is a xanthate gum
said step of converting includes grinding said sunflower seed husks into a powder;
said step of at least partially drying said slurry includes forming said slurry into a web and extracting moisture therefrom; and
said thermoplastic aliphatic polyester is applied to one side of said web while said first web is moist.

17. The method of claim 16 wherein said method includes forming said first web into a vessel and applying said thermoplastic aliphatic polyester to an inside surface of said vessel.

18. The method of claim 16 wherein said first web if formed to a thickness of at least 0.25 mm thick (0.010 inches).

19. The method of claim 16 wherein including forming said laminate into a paper cup.

20. A cardstock comprising a sunflower shell web with a thermoplastic aliphatic polyester coating applied to at least one side thereof.
